(19) United States
(12) Patent Application Publication
(10) Pub. No.: US 2025/0319972 A1
(43) Pub. Date: Oct. 16, 2025

(54) DEFROSTING SYSTEM FOR A MECHANICAL PART, COMPRISING AT LEAST ONE PIEZOELECTRIC ACTUATOR

(71) Applicants: PYTHEAS TECHNOLOGY, La Ciotat (FR); Avions de Transports Régional GIE (ATR), Blagnac (FR)

(72) Inventors: Frederic MOSCA, Meyreuil (FR); Simon CLEMENT, Meyreuil (FR); Alice AUBRY, Meyreuil (FR)

(73) Assignees: PYTHEAS TECHNOLOGY, La Ciotat (FR); Avions de Transports Régional GIE (ATR), Blagnac (FR)

(21) Appl. No.: 18/866,250

(22) PCT Filed: May 12, 2023
(86) PCT No.: PCT/EP2023/062813

§ 371 Date: Nov. 15, 2024

(30) Foreign Application Priority Data
May 16, 2022 (FR) FR2204615

(51) Int. Cl. B64D 15/12; F03D 80/40

(52) U.S. Cl. CPC B64D 15/12; F03D 80/401

(57) ABSTRACT

A defrosting (or de-icing) system mountable on a surface of a mechanical part to be de-iced, comprising including a piezoelectric actuator, a fastening device to secure the actuator to the surface, and at least one control unit to activate the actuator to excite the part for defrosting. The actuator features a stacked structure of prestressed piezoelectric elements along its longitudinal axis. The fastening device secures the actuator parallel to the surface and includes fastening elements at each end, enabling excitation of the part in extension and bending modes.

### TECHNICAL FIELD

The object of the present invention is a defrosting system for a mechanical part, comprising at least one piezoelectric actuator. Such a defrosting system is particularly—but not exclusively—adapted to a wind turbine blade, a leading edge of an aircraft or a turbomachine blade. The object of the invention is also a method for defrosting a mechanical part, using the aforementioned defrosting system.

In general, the invention relates to the technical field of defrosting, and more particularly to the defrosting systems using piezoelectric actuators. These defrosting systems are particularly advantageous in the field of renewable energy, such as wind energy, and aeronautics. These technical fields are however non-limiting, since the defrosting systems according to the invention can be easily adapted to other technical fields not mentioned.

### BACKGROUND

Certain mechanical parts, in particular in aeronautics, can be subjected to extreme temperatures. Indeed, the changes in altitude can lead to a large decrease in the temperatures. Frost can thus form on certain parts of the engines of airplanes, such as the blades or the vanes, or on the wings or the rear empennage. The accumulation of frost can drastically change the physical characteristics of the part and lead to a decrease in the performance of the engine, or to a change in the aerodynamic behaviour of the wings and of the empennage. The same applies to wind turbines, where the presence of frost on the blades can also reduce the performance, in particular in terms of efficiency.

This is why numerous defrosting systems, for various mechanical parts, have been developed. The most common defrosting systems are thermal systems, in which the heat produced allows to defrost the part. But these systems have a very high energy consumption.

Other systems use chemical products, but they pose a problem with regard to their mass, because they require large volumes of products to allow the defrosting. Moreover, these products are generally not environmentally friendly.

Thus, defrosting systems of the “mechanical” type using piezoelectric actuators have been developed more and more to make the part to be defrosted vibrate. They are indeed compact and light, have a low energy cost and are ecological.

The published patent document EP 2 433 868 B1 discloses a system for defrosting mechanical parts for the aeronautics industry. This system comprises devices emitting ultrasounds, such as piezoelectric actuators, positioned against an inner surface of the part. These piezoelectric actuators are inserted into housings and are controlled by a control unit that allows their activation. But these piezoelectric actuators are difficult to industrialise and are integrated into a maintenance structure relatively complex to manufacture and thus costly. Moreover, they are not very adaptable to curved surfaces.

The published patent document U.S. Pat. No. 9,155,430 B2 discloses a defrosting system for a motor vehicle windscreen comprising piezoelectric actuators. A method for defrosting said windscreen is also described. This method comprises a first step of transmitting ultrasonic waves to the surface of the mechanical part, then a second step of propagation of said waves through the part. The propagation of the waves allows to increase the temperature of the part, and thus its defrosting. But in practice, this type of system does not allow a very good defrosting insofar as the duration of such a defrosting is particularly long and depends greatly on the thickness of the frost on the windscreen. Moreover, the piezoelectric actuators are glued onto the part to be defrosted, which makes them not very robust to mechanical stresses, to shocks, and to humidity. Furthermore, their maintenance is relatively complex, or even impossible.

The invention aims to overcome all or a part of the disadvantages of the aforementioned prior art. More particularly, the goal of the invention is to propose a defrosting system with a piezoelectric actuator, the efficiency of the defrosting of which is improved with respect to the systems of the prior art. The goal of the invention is also to propose a defrosting system, the robustness of which is improved with respect to the systems of the prior art. The goal of the invention is also to propose a defrosting system, the design and the maintenance of which are simpler and less costly with respect to the systems of the prior art.

### SUMMARY

The solution proposed by the invention is a defrosting system configured to be mounted on a surface of a mechanical part to be defrosted, said system comprising at least:—a piezoelectric actuator; a fastening device configured to fasten the actuator onto the surface; —at least one control unit configured to activate the actuator so that it excites the part to defrost it.

This system is remarkable in that the actuator comprises a stack structure of prestressed piezoelectric elements acting along a longitudinal axis of said actuator. Moreover, the fastening device is configured to rigidly fasten the actuator so that the longitudinal axis is parallel to the surface. Furthermore, the fastening device comprises a fastening element positioned at each of the two ends of the actuator 9, which fastening elements are configured so that the activation of said actuator leads to the excitation of the part according to extensional and flexural modes.

The piezoelectric actuator according to the invention has a stack structure of prestressed piezoelectric elements (hereinafter “prestressed piezoelectric pillar”) providing excellent resistance to shocks, to humidity, to cycling over time, to stresses, as well as simplified repairability and maintenance. Moreover, after multiple trials, the applicant has noted that the orientation of the prestressed piezoelectric pillar parallel to the surface and its mode of fastening at its two ends offer the possibility of vibrating and exciting the part both according to its extensional modes but also according to its flexural modes. The capacity to be able to excite these two types of modes allows to obtain a defrosting system having a great adaptation ability, insofar as it is operational in multiple conditions of use.

The parallel positioning of the actuator with respect to the surface of the part further allows to avoid having the part bear damaging significant stresses when the latter undergoes significant accelerations, which can be the case in the field of aeronautics.

Further advantageous features of the apparatus that is the object of the invention are listed below. Each of these features may be considered alone or in combination with the remarkable features defined above. Each of these features contributes, where applicable, to solving specific technical problems defined earlier in the description and in which the remarkable features defined above are not necessarily involved. The latter may, where applicable, be the subject of one or more divisional patent applications:
According to one embodiment, the fastening of the actuator via the fastening elements is such that the distance between said actuator and the surface is between 0 and 10 mm, preferably between 3 mm and 8 mm.
According to one embodiment, the distance is adjustable.
According to one embodiment, the control unit is configured to activate the actuator according to a frequency between 1 KHz and 200 KHz and according to a voltage between 100V and 400V.
According to one embodiment, the control unit is configured to activate the actuator at a frequency less than or equal to its resonance frequency.
According to one embodiment, a counterweight is positioned at each of the two ends of the actuator, said counterweights being identical and disposed symmetrically with respect to the middle of said actuator.
According to one embodiment, the mass of the counterweights is such that the resonance frequency of the actuator corresponds to the resonance frequency of a mode of vibration of the part to be defrosted.
According to one embodiment, the actuator is connected to a second circuit configured to make said actuator operate according to a frost-detection mode.
According to one embodiment, the second circuit comprises a voltage generator used to activate the actuator according to a voltage between 1 mV and 10V and a means for analysing impedance of said actuator.
According to one embodiment, the data of analysis of impedance of said actuator is used by the control unit to measure and/or evaluate the thickness of the frost on the part.
According to one embodiment, the control unit is coupled to a switch having at least two positions: a first position in which the actuator is connected to a first circuit configured to make said actuator operate according to a defrosting mode, and a second position in which said actuator is connected to the second circuit configured to make said actuator operate according to the frost-detection mode.
According to one embodiment, the switch is only switched into the first position on the condition that the thickness of the frost measured and/or evaluated is greater than or equal to a predetermined threshold value.

The invention also relates to a method for defrosting a mechanical part, comprising the following steps:—transmission of an excitation to the mechanical part by one or more piezoelectric actuators of a defrosting system; —propagation of the excitation in the mechanical part, so as to allow the defrosting of said part.

This method is remarkable in that the system is according to one of the aforementioned features. Moreover, the method comprises a step of activation of the piezoelectric actuator(s) by the control unit, on the condition that the thickness of the frost on the part is greater than or equal to a threshold value, the activation step being anterior to the step of transmitting the excitation.

According to one embodiment, the method further comprises a step of detecting frost on the part anterior to the activation step.

According to one embodiment, the method comprises a step of measuring and/or evaluating the thickness of the frost, located between the detection step and the activation step.

The invention also relates to a mechanical part comprising at least one defrosting system according to one of the aforementioned features, which system is positioned on an inner or outer surface of the part.

According to one embodiment, the part is a wind turbine or aircraft blade, or a vane of an aircraft turbomachine.

### BRIEF DESCRIPTION OF THE DRAWINGS

Further advantages and features of the invention will emerge more clearly on reading the description of a preferred embodiment hereinafter, with reference to the appended drawings, made by way of indicative and non-limiting examples and wherein:

FIG. 1 is a transverse cross-section of a part equipped with a defrosting system according to the invention;

FIG. 2 diagrams a first embodiment of a defrosting system according to the invention;

FIG. 3 diagrams a second embodiment of a defrosting system according to the invention;

FIG. 4 diagrams a curve of variation of impedance (Z) of a piezoelectric actuator according to the activation frequency (f);

FIG. 5 illustrates an example of architecture of a system according to the invention and combining a defrosting function and a frost-detection function;

FIG. 6 is a diagram representing the various steps of a method according to the invention.

### DETAILED DESCRIPTION OF THE EMBODIMENTS

The invention can implement one or more computer programs executed by pieces of equipment. For reasons of clarity, it should be understood in the sense of the invention that “a step involves doing something”, “a piece of equipment does something” or “the computer program does something” means “the computer program executed by a processing unit does something.”

If necessary and to optionally complete their routine definition, the following specifications are given for certain terms used in the claims and the description:
The adjectives “inner” and “outer” define the positioning of a surface of the mechanical part, an inner surface designating a surface inside of the part, and an outer surface designating a surface outside of the part.
A step anterior to another step designates a step that takes place before said other step. Likewise, a step posterior to another step designates a step that takes place after said other step.
As used here, unless otherwise indicated, the possible use of the ordinal adjectives “first, “second”, etc. to describe an object or a step indicates simply that various occurrences of similar objects or steps are mentioned and does not mean that the objects or steps thus described must be in a given order, whether this is in time, in space, in a classification or in any other manner.
“X and/or Y” means: X alone or Y alone or X+Y.
In general, it should be understood that on the various appended drawings, the objects are arbitrarily drawn to facilitate their reading.

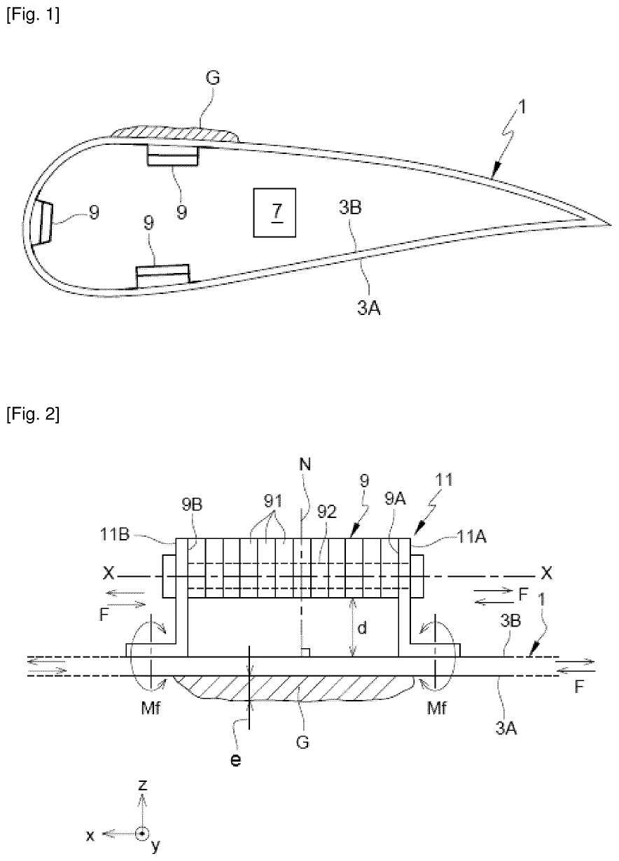

FIG. 1 shows a transverse cross-section of a mechanical part 1, more specifically of a wind turbine or aircraft blade. The mechanical part 1 comprises here a hollow structure 3 having an inner surface 3B and an outer surface 3A. This structure 3 is generally made from light materials, known to a person skilled in the art, for example aluminium sheets. As an illustrative example only, the description that follows refers to the defrosting of the blade 1, at the surface 3A of which frost G has accumulated. But the defrosting system forming the object of the invention applies however to any type of mechanical part that must be defrosted, such as wings and/or control surfaces of aircraft, windows, ventilation inlets, walls of a cold chamber, etc.

In FIG. 1, the defrosting system comprises one or more piezoelectric actuators 9, each fastened onto the surface of the part 1 via a fastening device. The piezoelectric actuators 9 are preferably fastened onto the inner surface 3B but could be fastened onto the outer surface 3A according to the uses.

At least one control unit 7 is configured to activate the actuator(s) 9 so that they excite the part 1 to defrost it. In practice, when the actuators 9 are activated by the unit 7 they vibrate the part 1, which vibrations allow to remove all or a part of the frost G.

The control unit 7 can be in the form of a processor, microprocessor, CPU (for Central Processing Unit) and associated with a memory in which one or more computer programs are recorded, the code instructions of which, when they are executed by said processor, microprocessor or CPU, allow to carry out the steps and/or functionalities described earlier in the description. A single unit 7 can carry out the activation of one or more actuators 9 simultaneously or sequentially. It is also possible to have several control units 7 that each activate one or more piezoelectric actuators in a determined zone of the part 1, for a specific and/or localised defrosting in this zone. The unit(s) 7 can be installed in the structure 3 or remotely from the latter.

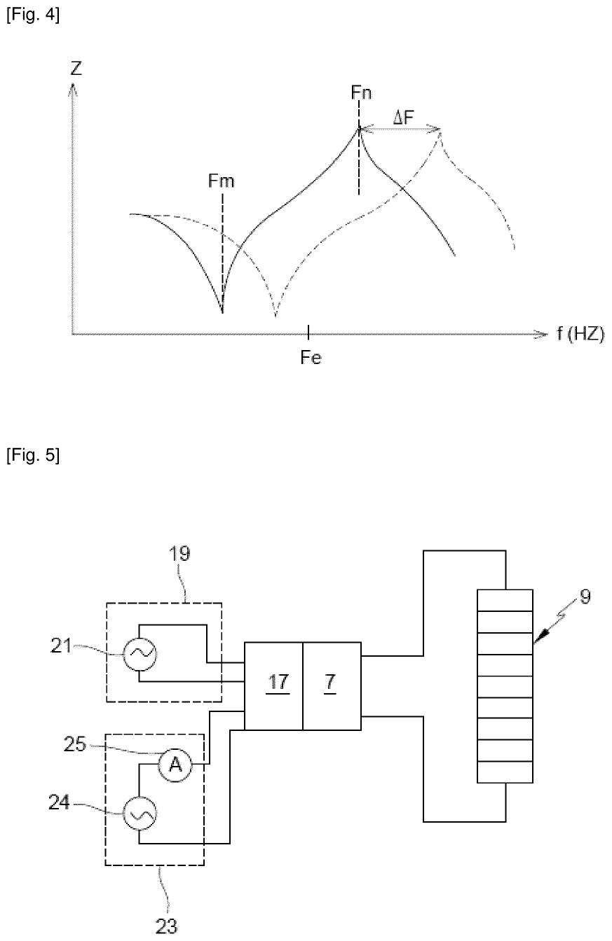

The actuator(s) 9 can also be used to detect the frost G and if necessary measure/evaluate its thickness e, between two defrosting phases. The same actuator 9 thus has a double function: defrosting and detecting frost. The unit 7 can thus adapt the frequency of activation of the actuator(s) 9 accordingly. The operation of an actuator in “frost detection” mode is described in more detail in the description in reference to FIGS. 4 and 5.

The piezoelectric actuators 9, the control unit 7 and, if necessary, the frost-detection devices can be connected in a wired manner (ex: by cable) or wirelessly, in particular by a short-range wireless connection of the type Bluetooth®, ANT®, ZigBee®, etc.

FIG. 2 illustrates a first embodiment of a piezoelectric actuator 9. The actuator 9 is configured to produce a mechanical energy when an electric field is imposed onto it. It comprises a stack structure of piezoelectric elements 91 (also designated hereinafter by the expression “piezoelectric pillar”). The piezoelectric elements 91 are advantageously in the form of piezoceramic or piezocomposite washers or discs, the diameter of which is for example between 3 mm and 50 mm. The number of washers or discs can vary from 2 to 400 according to the length of the pillar (which can be between 2 mm and 300 mm) and/or according to the mechanical force to be generated. For example, hard PZT (Lead Zirconate Titanate) ceramic washers are used. The pillar 9 can be resinated at the time of its mounting, outside of the part to be defrosted, increasing its durability by protecting it more from humidity, from dust, and from other environmental conditions.

When the actuator 9 is placed under voltage, its piezoelectric elements 91 deform elastically to generate a mechanical stress. The elastic deformation consists of an elongation of the piezoelectric pillar along the longitudinal axis X-X of the actuator 9. In other words, the actuator 9 elongates (extension) when it is placed under voltage. And when it is not placed under voltage, the actuator 9 retracts (contraction) and goes back to its original position. For example, the piezoelectric pillar is configured so that its range of movement between the phases of extension and of contraction is between 1 μm and 150 μm.

The actuator 9 is preferably prestressed to improve the robustness and the mechanical strength of the piezoelectric pillar. According to one embodiment, screwing elements engage with a rod 92 passing through the elements 91, so as to apply a prestress onto the piezoelectric pillar, by compression of said pillar. In FIG. 2, the axis of the rod 92 coincides with the longitudinal axis X-X.

The longitudinal axis X-X of the actuator 9 is parallel to the surface 3B (when disregarding the geometry and/or mounting tolerances). “Parallel” means parallel to the plane containing the zone of the surface 3B located facing the actuator 9 when said surface is flat in said zone. If the surface 3B is curved in this zone, “parallel” means the fact that the longitudinal axis X-X is perpendicular to the normal N to said surface passing through the middle of the actuator 9, or more roughly that the actuator 9 is tangent to said surface 3B.

A fastening device 11 is configured to fasten the actuator 9 so that the longitudinal axis X-X is parallel to the surface 3B. The fastening device 11 comprises a first fastening element 11A positioned at a first end 9A of the pillar 9, and a second fastening element 11B positioned at the second end 9B of said pillar. According to an advantageous feature of the invention, the fastening elements 11A, 11B are each in the form of a bracket or an L-shaped part, in order to simply ensure good parallelism between the longitudinal axis X-X of the actuator 9 and the surface 3B. The fastening elements 11A, 11B can be made of metal or of any other material suitable for a person skilled in the art and allowing to confer onto them sufficient rigidity to transmit the mechanical stresses of the actuator 9 to the part 1.

The fastening elements 11A, 11B can be rigidly fastened to the ends 9A, 9B via welding or via screwing elements that can be the same as those engaging with the rod 92 and used to prestress the pillar 9, or distinct screwing elements. Likewise, the fastening elements 11A, 11B can be rigidly fastened onto the surface 3B via screwing elements or via welding. The installation and the fastening of the defrosting system onto the surface 3B is thus very simple and very fast.

In this specific configuration in which the actuator 9 is installed parallel to the surface 3B and fastened to each of its ends 9A, 9B, the part 1 is able to be excited according to the flexural and extensional modes. The extension and the contraction of the pillar 9 along the longitudinal axis X-X induce extension forces F parallel to said longitudinal axis and which are mainly transmitted in the part 1 by the elements 11A, 11B. These extension forces F tend to generate the formation of cracks at the surface of the frost G and a fracturing of the latter, which can go all the way to delaminating it. These extension forces F also induce bending moments Mf (along the axis y in FIG. 2) at the zones of fastening of the elements 11A, 11B, which act as a lever. These bending moments Mf cause a flexural excitation of the part 1 (or at least of the surface 3B) allowing a fracturing and a delamination of the frost G. The part 1 can thus be excited according to two types of modes so as to optimise the vibrations of the structure in order to quickly and efficiently eliminate the frost G.

Since the fastening elements 11A, 11B act as a lever, the distance d separating the pillar 9 from the surface 3B play an important role in the flexural excitation. Indeed, the greater the distance d, the greater the intensity of this flexural excitation. In an opposite manner, if the distance d is close to 0, the intensity of the flexural excitation will be minimal, or even null. Thus, according to an advantageous embodiment, the distance d is between 0 mm and 10 mm, preferably between 3 mm and 8 mm. This distance d can be predetermined or adjustable, for example by using a system of oblong holes arranged in the elements 11A, 11B and in which the ends 9A, 9B are positioned. The optimal distance d can be defined empirically according to the characteristics of the frost G (ex: its composition, its microstructure) and/or of the part 1 and/or according to the extensional and/or flexural modes of excitation to be preferred to eliminate the frost G.

The activation of the actuator 9 is carried out by placing its piezoelectric elements 91 under voltage. This placement under voltage is managed by the control unit 7. For example, the control signal generated by the control unit 7 and applied to the actuator 9 can have a voltage between 20V and 400V, under an intensity of 1 mA to 10A. According to one embodiment, the frequency band for activation of the actuator 9 (frequency of the phases of extension and of contraction of the pillar) is between 1 KHz and 150 KHz and can reach 200 KHz. The control unit 7 can adapt the control signal in terms of voltage and/or in terms of intensity (ex: sinusoidal or square control signal) to optimise the performance in terms of mechanical stresses generated and/or vibration frequencies, etc.

The actuator 9 of FIG. 2 does not need to be activated at its specific resonance frequency to be efficient. The best results in terms of defrosting efficiency are obtained when the frequency of the vibrations generated by the actuator 2 corresponds to one or more resonance frequencies of the part 1 to be defrosted. These resonance frequencies depend substantially on the geometry, the material and the thickness of the part 1 and the thickness e of the frost G on said part.

Via its design, the actuator 9 of FIG. 2 can be excited over a wide frequency band (for example between 1 KHz and 150 KHz), which provides a large amplitude for adjustment according to the thickness of the frost. Its activation frequency can thus be easily adjusted to match at least one of the resonance frequencies of the part to be defrosted.

Moreover, the fact that the actuator 9 can be excited over a wide frequency band allows to simplify the design of the defrosting system. Indeed, in certain facilities, the defrosting system can include several actuators disposed on various parts. For example, an airplane wing is generally formed by various plates, the size and/or the shape of which can vary. For an installation of the defrosting system on this airplane wing, actuators 9 are fastened onto all or a part of these plates (that is to say the mechanical parts in the sense of the invention). It is not therefore necessary to specifically dimension each of the actuators according to the size and/or the shape of the plate onto which it is fastened. The actuators can on the contrary all be identical, and for example dimensioned to operate on the same range between 30 KHz and 60 KHz. It therefore suffices to adjust the activation frequency of each of the actuators differently to match it specifically to at least one of the resonance frequencies of the corresponding plate.

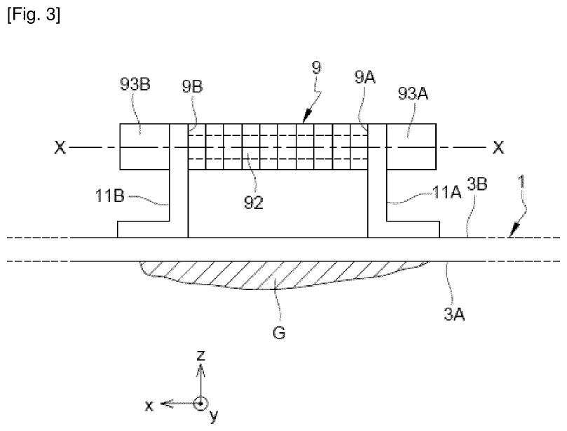

When a part 1 to be defrosted must be excited with a greater power density in the actuator (because of its size and/or its shape and/or its material and/or the thickness of the frost G), the actuator 9 can include counterweights. This is the second embodiment illustrated in FIG. 3. A first counterweight 93A is positioned at the first end 9A of the pillar 9, and a second counterweight 93B is positioned at the second end 9B of said pillar. Each end of the pillar 9 is thus provided with a counterweight. These counterweights 93A, 93B are identical and disposed symmetrically with respect to the middle of the pillar 9 so that the assembly is balanced. The counterweights 93A, 93B can be rigidly fastened onto the rod 92 or onto the fastening elements 11A, 11B, for example via screwing elements or via welds. The mass of the counterweights 93A, 93B depends on the resonance frequency sought for the actuator and can for example vary from 10 g to 500 g. In particular, the mass of the counterweights 93A, 93B is chosen so as to make the resonance frequency of the actuator 9 correspond to the resonance frequency of a vibrational mode of the part to be defrosted.

An actuator 9 according to FIG. 3 functions optimally when it is activated at its own resonance frequency, but provides good results in terms of defrosting for activation frequencies lower than its resonance frequency. Thus, this type of actuator 9 is preferably used when one or more resonance frequencies of the part to be defrosted do not significantly vary according to the thickness of the frost G. The actuator 9 is thus configured (in particular by the choice of the masses of the counterweights 93A, 93B) so that its own resonance frequency is matched to at least one of these resonance frequencies of the part to be defrosted.

Regardless of its embodiment, the actuator 9 can also be used to detect and measure, or at least evaluate, the thickness e of the frost G. According to one embodiment, this information on the presence and/or the thickness of the frost G is used as a piece of input data of the process for activating the defrosting system: if the value of the thickness measured/evaluated is less than a threshold value, then the defrosting mode is not activated. On the contrary, if the value of the thickness measured/evaluated is greater than or equal to a threshold value, then the defrosting mode is activated. And the activation frequency of the actuator 9 can be adapted to this measured/evaluated thickness.

According to one embodiment, the detection and the measurement of frost thickness are based on an analysis of the impedance data of the actuator 9, in order to carry out an identification of one or more resonance frequencies of the part 1. This analysis is preferably carried out by the unit 7.

The resonance frequency Fe of the part 1, without frost, at a resonance mode is of the type:

$$Fe = C \times \sqrt{\frac{k}{m}}$$

where: C is a coefficient, K the modal stiffness of the part and m the modal mass of said part.

In reference to FIG. 4, the curve (solid line) of impedance Z of the actuator 9 near this resonance frequency Fe has a characteristic trough (Fm) and peak (Fn). The impedance Z corresponds to the ratio between the voltage U and the intensity I of the electric current applied to the piezoelectric pillar 9 (Z=U/I). The values of this reference impedance curve are recorded in a memory zone of the system that can be the memory zone of the unit 7 or another dedicated memory zone.

In the case of frost, the resonance frequency Fe′ of the part 1 becomes:

$${Fe}^{′} = C \times \sqrt{\frac{{k}^{′}}{{m}^{′}}}$$

where: k′>k (since the frost is embedded at the surface 3B, the part 1 becomes stiffer) and m′>m (m′=m+m_{G}, with me the mass of frost).

According to a particularly advantageous embodiment, the detection of frost is carried out by activating the piezoelectric pillar 9 with a voltage value that is low, that is to say between 1 mV and 10V. The pillar 9 is activated over a range of frequencies around the resonance frequency Fe, for example over the range [X.Fe; Y.Fe], with 0.1≤X≤0.9 and 1.1≤Y≤2. The impedance of the pillar 9 is thus measured at each scanned frequency of the frequency range.

The values measured are then compared by the unit 7 to those of the reference impedance curve. If the measured impedance curve coincides with the reference impedance curve, then this means that there is no frost on the part 1. Inversely, a deviation ΔF of the measured impedance curve (dotted line in FIG. 4) from the reference impedance curve (frequency offset) indicates the presence of frost on the part 1.

The value of this deviation ΔF allows to measure/evaluate the thickness of the frost. Indeed, series of measurements of impedance can be previously carried out with various thicknesses of frost and stored in a memory zone of the system. Thus, a comparison of the measured values to these known values allows the unit 7 to deduce the thickness of the frost, as well as the resonance frequency of the part 1 to be defrosted.

FIG. 5 shows an example of architecture of the system combining the defrosting function with the frost-detection function. The actuator 9 is connected to the control unit 7. A switch 17 has the function of switching the system between the “defrosting mode” and the “frost detection” mode. The switch 17 can be activated manually or automatically by the unit 7. In a first position, this switch 17 allows to connect the actuator 9 to a first circuit 19 comprising a high-voltage generator 21 (ex: 20V to 400V) used to activate said actuator in defrosting mode. In a second position, the switch 17 is connected to a second circuit 23 comprising a low-voltage generator 24 (ex: 1 mV to 10V) used to activate the actuator 9 in frost-detection mode. The second circuit 23 also includes a means for analysing impedance 25 that can for example simply consist of an ammeter adapted to measure the intensity passing through the actuator 9. The impedance-analysis data is used by the unit 7 to trigger the switching of the switch 17. The circuits 19 and 23 can be in the form of electronic cards connected to the unit 7.

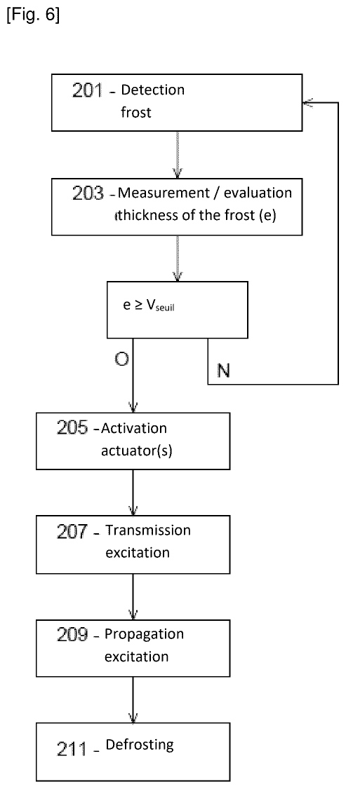

FIG. 6 repeats the various steps of the defrosting method according to the invention. Steps 201 and 203 are optional.

This method comprises a first step 201 of detecting frost G on the part 1. The switch 17 selects the second circuit 23. The pillar 9 is activated in low voltage over a predefined range of frequencies so as to carry out impedance measurements as explained above. The analysis of impedance allows to detect the presence of frost or not.

A second step 203 allows to measure/evaluate the thickness e of the frost G, on the basis of the impedance measurements. If the value e of frost thickness measured/evaluated is less than a predetermined threshold value Vₛₑᵤᵢₗ (for example 0.3 mm), the switch 17 is not switched and the defrosting of the part 1 is not activated. However, if the value e of frost thickness measured/evaluated is greater than or equal to the threshold value Vₛₑᵤᵢₗ, then the switch 17 is switched and the defrosting is activated. In this case, the switch 17 is switched to select the first circuit 19.

A third step 205 involves activating the actuator(s) 9. The actuators 9 can be activated locally, if the analysis of the thickness of frost is localised, or over the entirety of the part 1. The activation frequency can be pre-parameterised or preferably adjusted according to the thickness of frost measured/evaluated so that the activation frequency coincides with the resonance frequency of the part 1 having frost.

A fourth step 207 corresponds to the transmission of the excitation, produced by the piezoelectric actuator(s) 9 of the part 1 via the fastening elements 11A, 11B.

A fifth step 209 corresponds to the propagation of the excitation in the part 1. In the context of the invention, the excitation transmitted by the actuator(s) 9 is flexural and/or extensional. This propagation can be localised in a precise zone of the part 1 or be transmitted to the entirety of the part 1.

The step 209 leads to a sixth and last step 211 of defrosting. The excitation of the part 1 allows a fracturing and a delamination of the frost by vibration according to one or more of its modes of vibration.

The arrangement of the various elements and/or means and/or steps of the invention, in the embodiments described above, should not be understood as requiring such an arrangement in all the implementations. In any case, it will be understood that various modifications may be made to these elements and/or means and/or steps, without deviating from the spirit and the scope of the invention.

Furthermore, one or more features disclosed solely in one embodiment can be combined with one or more other features disclosed solely in another embodiment. Similarly, one or more features disclosed solely in one embodiment may be generalised to the other embodiments, even if this or these feature(s) are described merely in combination with other features.

The use of the verb “include”, “comprise” or “contain” and of its conjugated forms does not exclude the presence of elements or steps other than those set out in a claim.

1-17. (canceled)

18. A defrosting system configured to be mounted on a surface of a mechanical part to be defrosted, the system comprising:
a piezoelectric actuator,
a fastening device configured to fasten the actuator onto the surface,
at least one control unit configured to activate the actuator through phases of extension and contraction so that it excites the mechanical part to defrost it, and the actuator comprises a stack structure of prestressed piezoelectric elements acting along a longitudinal axis of said actuator, and
the fastening device is configured to rigidly fasten the actuator so that the longitudinal axis is parallel to the surface,
wherein the fastening device comprises a first fastening element positioned at a first end of the actuator and a second fastening element positioned at a second end of said actuator, these fastening elements being, in use, secured to the surface of the mechanical part to be defrosted,
wherein the fastening elements are configured so that the activation of said actuator leads to the excitation of the mechanical part according to extensional and flexural modes,
wherein the extension and contraction of the actuator along the longitudinal axis induce extension forces parallel to said longitudinal axis, wherein the extension forces also generate bending moments at the fastening area of the first fastening element and at the fastening area of the second fastening element, and
wherein the fastening elements act as levers, causing a bending excitation of the mechanical part to be defrosted.

19. The defrosting system according to claim 18, wherein the first fastening element and the second fastening element are each in the form of an angle bracket or L-shaped piece.

20. The defrosting system according to claim 19, wherein the fastening of the actuator via the fastening elements is such that the distance between said actuator and the surface is between 0 and 10 mm.

21. The defrosting system according to claim 20, wherein that the distance is adjustable.

22. The defrosting system according to claim 18, wherein the control unit is configured to activate the actuator according to a frequency between 1 KHz and 200 KHz and according to a voltage between 100V and 400V.

23. The defrosting system according to claim 18, wherein the control unit is configured to activate the actuator at a frequency less than or equal to its resonance frequency.

24. The defrosting system according to claim 18, wherein a counterweight is positioned at each of the two ends of the actuator, said counterweights being identical and disposed symmetrically with respect to the middle of said actuator.

25. The defrosting system according to claim 24, wherein the mass of the counterweights is such that the resonance frequency of the actuator corresponds to the resonance frequency of a mode of vibration of the mechanical part to be defrosted.

26. The defrosting system according to claim 18, wherein the actuator is connected to:
a first circuit configured to activate said actuator in defrosting mode, and
a second circuit configured to make said actuator operate according to a frost-detection mode.

27. The defrosting system according to claim 26, wherein the second circuit comprises a voltage generator used to activate the actuator according to a voltage between 1 mV and 10V and a means for analysing impedance of said actuator.

28. The defrosting system according to claim 25, wherein the data of analysis of impedance of said actuator is used by the control unit to measure and/or evaluate the thickness of the frost on the mechanical part.

29. The defrosting system according to claim 26, wherein the control unit is coupled to a switch having at least two positions: a first position in which the actuator is connected to the first circuit configured to make said actuator operate according to a defrosting mode, and a second position in which said actuator is connected to the second circuit configured to make said actuator operate according to the frost-detection mode.

30. The defrosting system according to claim 28, wherein the switch is only switched into the first position on the condition that the thickness of the frost measured and/or evaluated is greater than or equal to a predetermined threshold value.

31. A method for defrosting a mechanical part, comprising the following steps:
transmitting an excitation to the mechanical part by one or more piezoelectric actuators of a defrosting system,
propagating the excitation in the mechanical part, so as to allow the defrosting of the mechanical part,
wherein the defrosting system is as defined in claim 18,
and the defrosting method further comprises a step of activating the one or more piezoelectric actuators by the control unit when the thickness of the frost on the mechanical part is greater than or equal to a threshold value, the activating being anterior to the step of transmitting the excitation.

32. The defrosting method according to claim 30, further comprising a step of detecting frost on the mechanical part anterior to the activation step.

33. The defrosting method according to claim 31, further comprising a step of measuring and/or evaluating the thickness of the frost, located between the detection step and the activation step.

34. A mechanical part comprising at least one defrosting system as defined in claim 18, wherein the defrosting system is positioned on an inner or outer surface of the mechanical part.

35. The mechanical part according to claim 33, wherein said mechanical part is a wind turbine or aircraft blade, or a vane of an aircraft turbomachine.
